(19) United States
(12) Patent Application Publication
(10) Pub. No.: US 2004/0181082 A1
(43) Pub. Date: Sep. 16, 2004

(54) Palladium catalyst and processes for using the same

(76) Inventor: Linwood Anderson, Roscoe, IL (US)

Correspondence Address: MINTZ LEVIN COHN FERRIS GLOVSKY & POPEO, 666 THIRD AVENUE, NEW YORK, NY, 10017, US

(21) Appl. No.: 10/415,714

(22) PCT Filed: Apr. 11, 2002
(86) PCT No.: PCT/US02/11386

(30) Foreign Application Priority Data
Apr. 12, 2001 (US) 09833945

(51) Int. Cl. C07F 15/00

(52) U.S. Cl. 556/136

(57) ABSTRACT

A catalyst for the manufacture of acrylic acid or methacrylic acid by the oxidation of propylene, acrolein, or isobutylene whereby said catalyst is prepared by reducing a palladium salt or palladium metal to palladium with a reducing agent such as propylene in an oxygen-free single or two phase aqueous organic solvent containing as a co-solvent a maximum concentration of a C₂-C₆ carboxylic acid or C₃-C₆ ketone.

### RELATIONSHIP TO PRIOR APPLICATIONS

This application is a continuation-in-part of U.S. patent application Ser. No. 09/833945, filed Apr. 12, 2001.

### BACKGROUND OP THE INVENTION

Acrylic acid is manufactured commercially by the vapor-phase oxidation of propylene or acrolein with an oxygen-containing gas. The oxidation of propylene is generally carried out at a temperature of from about 300 to about 450° C. in the presence of water vapor or steam and a catalyst comprising predominately Mo—Bi—W oxides. A second stage oxidation is then carried out at lower temperature with a Mo—V catalyst to convert the mainly acrolein to acrylic acid. These oxidations are generally carried out at atmospheric pressure. The reaction mixture is quenched in water arid than the acrylic acid is recovered therefrom by distillation.

Several “new generation” methods for the oxidation have been proposed. The most promising is to carry out the oxidation in liquid phase utilizing a palladium catalyst.

The methods for the manufacture of acrylic acid from the palladium-catalyzed oxidation of propylene using an oxygen-containing gas in water or an aqueous medium have been previously disclosed in the literature. Disclosures include methods to activate the catalyst and co-solvents to improve the solubility of the components in the aqueous solution.

Literature references which specifically disclose methods to activate the catalyst and use of the catalyst to oxidize propylene to acrylic acid in aqueous solution include the following:

David and Estienne, U.S. Pat. No. 3,624,147, discloses the oxidation in water using various forms of palladium metal including unsupported palladium. The supported palladium is disclosed as being supported on silica gel, silica-alumina and carbon. The oxidation was carried out at 50-60 bar pressure.

Various forms of palladium catalyst useful for the reaction are discussed by Seiyama et. al., Catalytic Oxidation of Olefins over Metallic Palladium Suspended in Water, J Catalyst, 173 (1972). Unsupported Pd catalyst is manufactured by the reduction and activation of palladium chloride.

The exposure of palladium on carbon to propylene in a oxygen free atmosphere prior to its use as an oxidation catalyst (for the oxidation of propylene to acrylic acid in water containing the free radical inhibitor BHT) was disclosed by Lyons, Dependence of Reaction Pathways and Product Distribution on the Oxidation State of Palladium Catalysts for the Reactions of Olefinic and Aromatic Substrates with Molecular Oxygen, in Oxygen Complexes and Oxygen Activation by Transition Metals, Martell and Sawyer, ed., Plenum Press, (1988).

Lyons and Suld, EP 145 467 B1, discloses activating palladium metal on a carbon or alumina support to an oxygen-free atmosphere of propylene at about 60-150° C. for from 10-120 minutes at 1-100 atmospheres prior to using the catalyst for the oxidation of propylene to acrylic acid in an aqueous solution. This catalyst (at 1-10 atmospheres and 25-85° C.) oxidized propylene in an aqueous solution.

Suld and Lyons, EP 145 468 A2, discloses the use of the above catalyst (EP 145 467 B1) to manufacture acrylic acid in an aqueous solution containing a surfactant and a cosurfactant. The surfactant was sodium dodecyl sulfate and the co-surfactant was a C₃-C₄ alkyl alcohol.

Lyons, EP 145 469B1, discloses the use of the catalyst of Lyons and Suld above (EP 145467 B1) in the oxidation of propylene to acrylic acid in an aqueous solution containing a free radical inhibitor, i. e., BHT.

Pasichnyk et. al., Oxidation of Propylene to Acrylic Acid and its Esters Catalyzed by Palladium Giant, Mendeleev Commun. (1994), (1), 1-2 [CAPLUS Document No. 120: 245831] discloses the oxidation of propylene using giant crystals of palladium.

Hinnenkamp, U.S. Pat. No. 4,435,598, discloses the use of Pd/C catalyst in aqueous solution using hydroquinone.

Zohra Ferhat-Hamida et. al., Applied Catalysis B-Environmental 29(2001) 195-205, discloses the reduction of palladium oxide with propylene at above 150° C. and the use of the resulting form of palladium to oxidize alkenes to CO₂ and water.

Xibin Yu, Minghui Wang, and flexing Li, “Study on the nitrobenzene hydrogenation over a Pd—B (SiO₂ amorphous catalyst”, Applied Catalysis A: General 202 (2000) pp 17-22, discloses the use of a Pd—B/SiO₂ amorphous alloy catalyst, but states that no Pd-based amorphous catalysts (per se) have been reported.

Thus the prior art recognizes the use of a Pd (alloy) catalyst but no Pd catalyst per se in substantially amorphous form has been forthcoming.

All of the prior art including any literature references set forth herein are incorporated herein by reference in their entirety.

### SUMMARY OF THE DISCLOSURE

One facet of the present invention relates to a new Pd catalyst which is substantially amorphous in character, supported or unsupported, and is prepared by reducing a Pd salt or a Pd metal in the presence of an aqueous organic solvent with a reducing agent which is capable of rendering the Pd material substantially amorphous.

Another facet of the present invention relates to the manufacture of acrylic acid and methacrylic acid and the esters thereof from the unsupported palladium-catalyzed oxidation of propylene or isobutylene respectively in an aqueous solution utilizing an oxygen-containing gas. This part of the invention also encompasses the oxidation of acrolein to acrylic acid and esters and the oxidation of methacrolein to methacrylic acid esters according to the same method.

The unique and inventive methods of this invention differ from the prior art methods disclosed above in that the palladium catalyst is a substantially amorphous, finely divided unsupported metal manufactured in situ by the reduction and activation of a Pd salt such as palladium acetate or a palladium metal in one step. The reduction is carried out with a reducing agent which is capable of forming a substantially amorphous Pd such as propylene in an oxygen-free aqueous organic solvent containing a C₂-C₆ carboxylic acid, tert.-alcohols or CrC₆ ketones as co-solvents. If the desired product is acrylic acid or methacrylic acid, propylene, acrolein, isobutylene, or methacrolein and an oxygen-containing gas are then introduced into the mixture in a continuous manner and the resulting aqueous acid is continuously removed. The acid is separated by distillation in a manner well known to the art and discussed in the prior art references. The aqueous residue is then continuously returned to the reactor to maintain a constant level in the reactor. If the esters are the desired product, the reduction is carried out with propylene in an oxygen-free aqueous solution containing the appropriate alcohol. Thereafter, propylene, acrolein, isobutylene, methacrolein and an oxygen-containing gas are then introduced into the mixture in a continuous manner and the product is recovered by methods well known in the art with the solvent mixture being returned to the reactor.

### DESCRIPTION OF THE DRAWINGS

FIG. 1 sets forth the carbon efficiency and the STY of the reaction of Example 1.

FIG. 2 shows the solvent recycle rate for Example 1.

FIG. 3 identifies the STY and a Constant Volume STY for Example 2.

FIG. 4 sets forth a plot of the selectivity to a mixture containing methacrolein, methacrylic acid, and esters as determined by vapor phase chromatography during the continuity of the run of Example 2.

FIG. 5 sets forth the pressure drop versus time of propylene oxidation in various solvents.

FIG. 6 contains X-ray diffraction patterns for commercially available (crystalline) Pd and Pd (substantially amorphous) produced by the reduction of a Pd salt.

FIG. 7 sets forth the X-ray diffraction pattern for Pd (crystalline form) from the vapor phase reduction of a Pd salt at 220° C.

FIG. 8 discloses the X-ray diffraction patterns of a Pd salt reduced with different reducing agents.

FIG. 9 sets forth the effect of oxygen consumed versus time using different Pd catalysts.

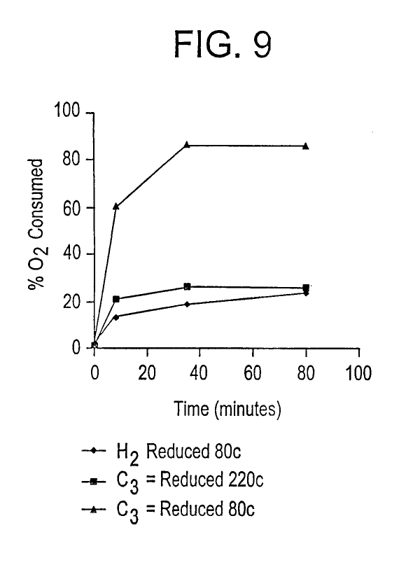

FIG. 10 sets forth the X-ray diffraction patterns of a Pd catalyst produced from an aqueous solution, i.e. without an organic co-solvent.

FIG. 11 sets forth the X-ray diffraction patterns of a Pd catalyst produced from an aqueous solution with an organic solvent.

### DETAILED DESCRIPTION OF THE INVENTION

In one facet of the present invention, it has been found that palladium (Pd) when reduced by a reducing agent forms either a crystalline or a substantially amorphous Pd material which functions as a catalyst. The substantially amorphous Pd was heretofor unknown. The crystalline Pd (unreduced) was generally used in the past as an alloy, i.e. with other metals or materials. The palladium catalyst is prepared in the oxidation reactor prior to the oxidation reaction. The preparation of the catalyst involves dissolving a palladium salt such as palladium acetate in the single or two-phase solvent, discussed below, flushing the solution and vessel with a gas inert to the reaction, and contacting the solution with a reducing agent such as propylene in a vigorous manner, as for example by stirring, rapid agitation, or by a similar method. The inert gas may be nitrogen, helium, argon, krypton, or the like inert gases. Typically the reaction is complete in about 1-2 hours at 60-90° C. at a pressure of from about 1 to about 50 bars. One skilled in the art, however, would recognize that the temperature could be increased or decreased as needed. Temperature ranges of from 50-150° C. can be used. Reaction times of 0.5-5 hours might be needed to complete the reaction at such other temperatures. According to the Law of Mass Action, the higher temperatures will allow the reaction to be completed in a shortened amount of time, but will lead to a greater amount of undesired products. It has been found that there is no advantage to carry out the reaction at elevated pressures. One to ten bar gauge pressures are typical.

The reduction process to prepare the catalyst can be carried out in separate reaction with, for example, oxygen free propylene. If the reduction is carried out in a manufacturing process separate and apart from the acid production process, care must be taken to separate and store the freshly reduced catalyst, particularly to separate and store the catalyst away from oxygen or al oxidizing atmosphere. Use of freshly reduced catalyst is to be desired since catalyst stored for extended periods tends to lose activity to the manufacture of the desired product. Catalyst prepared in the acid manufacturing equipment and used without further manipulation is to be preferred, although the use of stored catalyst is not outside the invention, nor the claimed method of this invention. The catalyst, when prepared separately, is generally stored under water, which has been appropriately treated to remove air or gaseous oxygen as for example by bubbling purified nitrogen therethrough. The catalyst, which if separately stored, tends to clump, is separated and dispersed by immersion in an ultrasonic bath prior to use. Thus, the catalyst tends to clump and must be stirred or agitated rapidly in order to avoid clumping which reduces the activity.

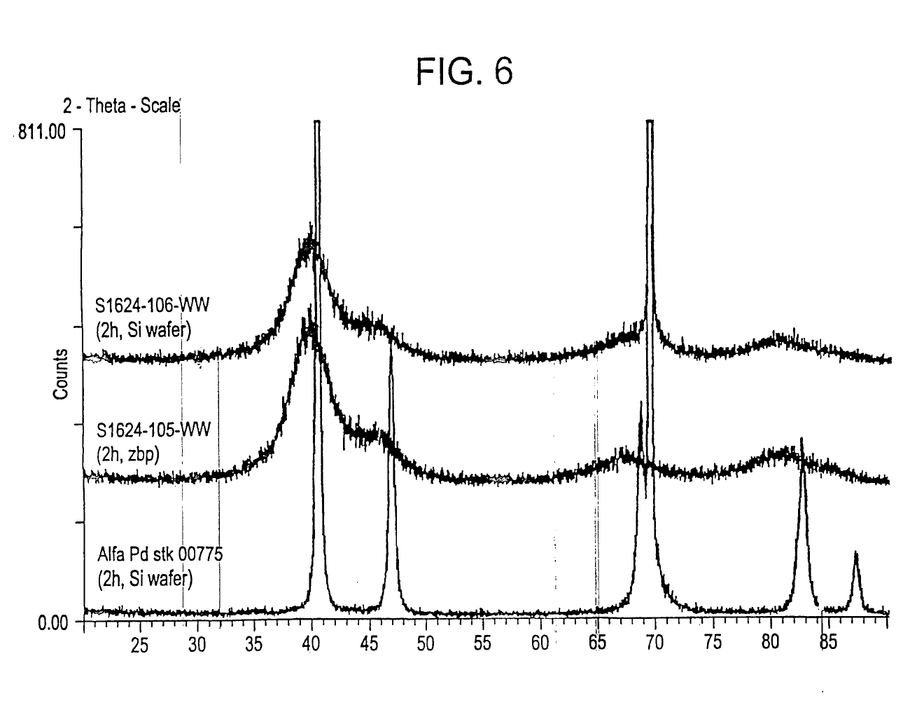

The effect of non-reduction versus reduction, and the reducing agent per se is shown in FIGS. 6, 7 and 8.

FIG. 6 contains X-ray diffraction patterns for Alfa Pd which is purchased palladium metal with particle size of <1 micron from Alfa Inc. The other two scans labeled 51624-105 WW is palladium metal produced by reduction with propylene in valeric acid/water solvent starting from palladium acetate. The palladium acetate is completely soluble in the valeric acid/water solution before the reduction with propylene at 80 degrees C and 80 psig.

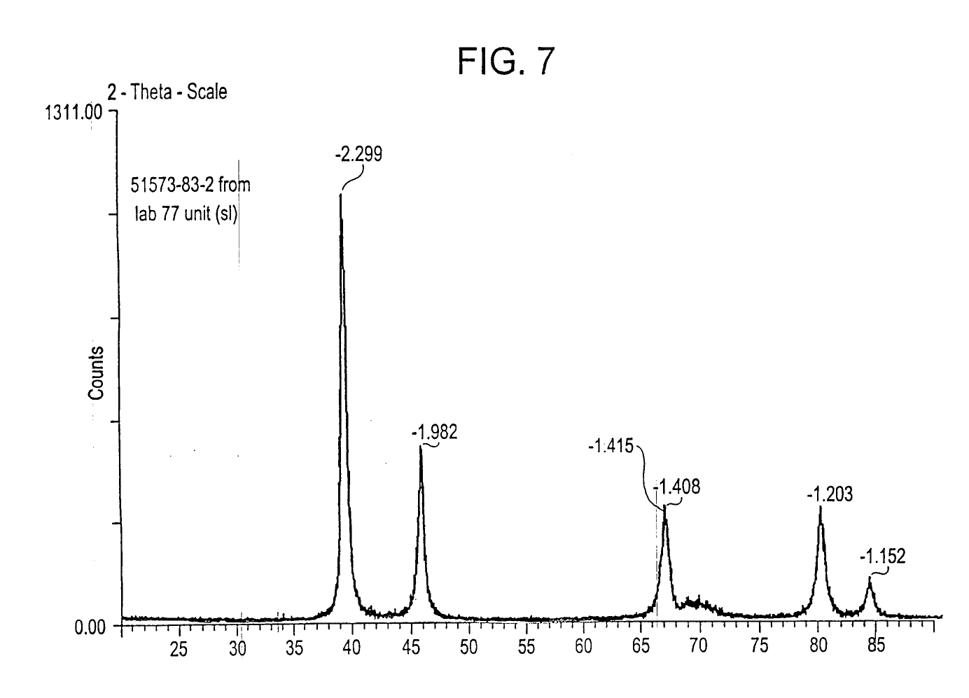

FIG. 7 contains the X-ray diffraction pattern for palladium produced by vapor phase reduction of palladium acetate at 220° C. The palladium acetate was packed in a tube and gaseous propylene in nitrogen was passed Sough the acetate and the tube was heated to 220° C.

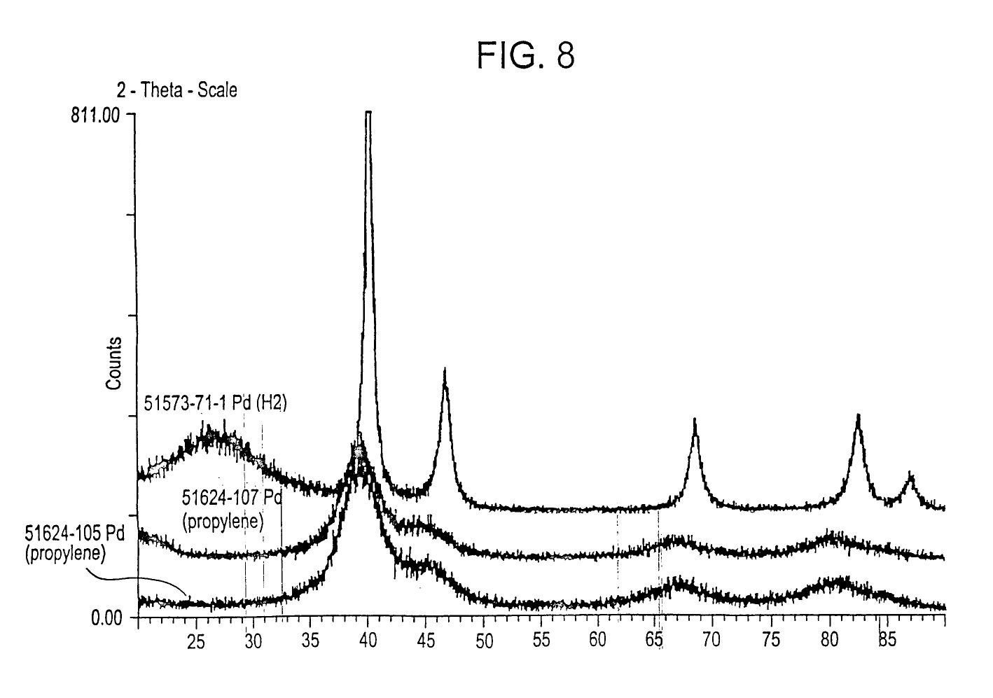

FIG. 8 contains X-ray diffraction patterns for 51624-105 (same as FIG. 6) and a separate batch of Pd produced by liquid phase reduction of palladium acetate in valeric acid/water labeled as 51624-107. The X-ray diffraction pattern labeled 51573-71-1 is palladium metal produced by liquid phase reduction of palladium acetate in valeric acid/water using hydrogen as the reducing agent at 80° C. and 80 psig.

It is noted in FIG. 8 that the palladium catalyst reduced in propylene is less dense than Pd reduced in hydrogen. This is demonstrated by the d-spacing shift observed in X-ray (XRD) studies. D-spacing is the distance between parallel lattice planes in a crystalline structure and is a function of the lattice parameters that define a unit cell. Under Hamida's conditions [Hamida, Z. F., et. al. Applied Catalysis B:Env. 2001 29 195-205], hydrogen-reduced Pd has an XRD pattern with a major peak at d=2.245 A. When propylene is used, the Pd catalyst formed has a similar pattern with the major reflection at d=2.300 A (shift=0.055 A). The present invention Pd catalysts have similar XRD patterns that demonstrate the same difference in d-pacing when the catalyst is reduced with hydrogen versus propylene. Under the present invention conditions, Pd catalyst reduced in hydrogen has the major reflection at d=2.239 A while the same reflection in the propylene-reduce catalyst shifts by 0.055 A to d=2.285 A.

Hamida documented Pd catalysts that have very narrow peak profiles regardless of the reducing agent used. The present invention conditions produce Pd catalyst with narrow peak profiles when hydrogen is the reducing agent, but have broadened peak profiles when propylene is the reductant. Peak broadening indicates a less ordered crystalline lattice or small crystallites or substantially amorphous material. A crystallite is the smallest diffracting domain in a specimen. Crystallites from one to several hundred nanometers have broadened peak profiles. Note that crystallite size should not be confused with particle size. A particle may contain many crystallites. Peak profiles indicate that Hamida's catalysts and the present invention hydrogen-reduced catalyst have large crystallites with highly ordered crystalline lattices. The present invention propylene-reduced Pd catalyst has smaller crystallites and a less ordered crystalline lattice, or a substantially amorphous material.

In X-ray diffraction, peak widths in a particular phase pattern provide indication of crystallite size. A crystallite is defined as “the portion of a crystal whose atoms, ions or molecules form a perfect lattice, without strains or imperfections, [Hawley, G. G. Condensed Chemical Dictionary. 10^{th} ed., 1981]. Note that a particle may be composed of several crystallites. Large crystallites give rise to sham peaks. Peak width increases as crystallite size decreases. Small crystallites denote less order in the crystalline lattice.

For a crystal to diffract, the planes of atoms (reflective planes) in the structure must meet the incident X-ray beam at a set of specified angles such that the x-rays reflected from different points on these planes meet the detector in phase (the path lengths differ by multiples of 1 wavelength). When the crystallite is large, there are thousands of parallel planes and the resulting reflections of the phased X-rays are sharp. As crystallites become smaller, there are fewer parallel planes. The resulting reflections are uniformly broad (and decreased in height such that the area under the peak remains constant) due to incomplete destructive interference. There are rigorous mathematical methods for determining crystallite size based on peak width. Generally, crystallites ranging in size from one to several hundred nanometers have broadened peak profiles, [Azaroff, L. V.; Buerger, M. J. The Powder Method in X-ray Crystallography, McGraw-Hill, 1958) thus indicating that the material has little/reduced order in the crystal lattice and thus is substantially amorphous.

In another facet of the present invention, there is provided a method for preparing acrylic acid and methacrylic acid which can be manufactured in high conversion and yield by carrying out the oxidation of propylene and isobutylene respectfully in an aqueous organic solution in the presence of reduced palladium catalyst, which is either supported or unsupported.

U.S. Pat. No. 3,624,137 and other prior art disclose the use of supports such as carbon, alumina, SiO₂ and other supports, such as Ambersorb, for the catalyst. The prior art also discloses the use of water and aqueous solutions containing free radical inhibitors, as for example BHT, as the medium for the oxidation. The prior art further discloses the presence of lower alkyl alcohols as additives to the aqueous solution during the oxidation reaction to increase the solubility of the reactants.

Thus, this embodiment of the present invention pertains to a method for the manufacture of acrylic acid and methacrylic acid which comprises: a) continuously reacting oxygen with the precursor in the presence of an unsupported or supported palladium catalyst suspended in an aqueous organic solvent system containing as a co-solvent a C₂-C₆ carboxylic acid, tert.-butanol, or C₃C₆ ketone, b) recovering the acrylic acid formed, and c) recycling the aqueous solvent to the reactor. The catalyst reduction is efficiently carried out with a reducing agent such as propylene. The solvent system may or may not be a single-phase system. Preferably, the solvent system is a single-phase system containing a saturation concentration of co-solvent. For the method of this invention, the term precursor is defined as follows: (1) for the manufacture of acrylic acid and ester, the precursor is propylene or acrolein or mixtures thereof, and (2) for the manufacture of methacrylic acid and esters, the precursor is isobutylene or methacrolein.

The novel oxidation reaction of this invention is carried out continuously by passing the precursor and an oxygen-containing gas into a reactor containing the catalyst in an aqueous organic solvent containing an appropriate amount of a co-solvent as defined hereinbelow and removing the product acid by continuously separating the liquid component from the solid catalyst, removing a portion of the catalyst-free solvent, separating the product therefrom, and recycling the solvent. Temperatures in the reactor are preferably from about 0° C. to about 150° C. and pressures are from about 1 bar to about 50 bars. The molar ratio of precursor to oxygen is preferably above 1:1, but is most preferably from about 1:1to about 1:5. Oxygen-containing gases may be pure oxygen or mixtures of oxygen with other gases that are inert to the reaction. Examples of such gases are air, and oxygen-containing mixtures, as for example oxygen-nitrogen, oxygen-helium, oxygen-argon, and the like mixtures.

When acrylic acid or methacrylic acid is the desired end product, a single phase or two-phase aqueous organic solvent is utilized with a co-solvent comprising a C₂-C₆ carboxylic acid, tert.-butanol, or C₃-C₆ ketones. The co-solvent is advantageous to the solubility of the components in the oxidation reaction. The preferred acids include acetic acid, propionic acid, butryic acid, valeric acid, and hexanoic acid. Acids with a lower boiling point are effective in promoting the reaction but are more difficult to separate from the desired product in the reaction mixture, needlessly complicating the separation of the acid during separation and purification. Higher fatty acids are detrimental to the reaction and should be avoided. Ketone co-solvents are preferred in the manufacture of methacrylic acid. The preferred ketones include acetone, methyl ethyl ketone, methyl isobutyl ketone, and the like. The most preferred co-solvent for the manufacture of methacrylic acid is methyl isobutyl ketone. The most preferred solvent for the manufacture of acrylic acid is valeric acid. Primary and secondary alcohols are to be avoided as co-solvents to prevent a possible reaction with the formed acrylic acid or methacrylic acid to manufacture ester by-products and oxidation of the secondary alcohols to ketones, which would reduce the yield of desired product and would complicate the separation process.

If the C₁-C₆ esters are to be manufactured as the desired product, the primary alcohol of the reaction sequence is an appropriate co-solvent, although it may be augmented by the above defined acids, ter.-alcohols, or ketones. The C₁-C₆ primary alcohols are methanol, ethanol, propanol, n-butanol, isobutanol, n-pentanol, 2-methyl-1-butanol, 3-methyl-1-butanol, n-hexanol, 2-ethyl-1-butanol, and the like.

Separation of the product from the catalyst is accomplished by methods well known in the art, as for example, by filtration, decantation, centrifugation, distillation, and the like. In the continuous mode of operation of the oxidation reaction of this invention separation is ideally accomplished by use of a filter. The filter may be internal to the reaction vessel, as for example a candle filter, or external to tie reactor. Separation of the product acid or ester from the solvent is carried out by distillation or decantation and distillation. The solvent is then recycled to the reactor.

Preferred separation of acrylic acid from valeric acid is by fractional distillation. The water forms an azeotrope with several of the low-boiling byproducts and is removed first. The acrylic acid then is recovered, and the higher-boiling valeric acid is returned to the reactor. No additional water is added with the recycle since the byproduct water in the reactor is sufficient to act as the aqueous solvent.

Preferred separation of methacrylic acid from methyl isobutyl ketone is accomplished by decantation of the organic layer, fractional distillation of the recovered organic layer, and return of the ketone to the reactor. Again no additional water need be added with the recycled solvent.

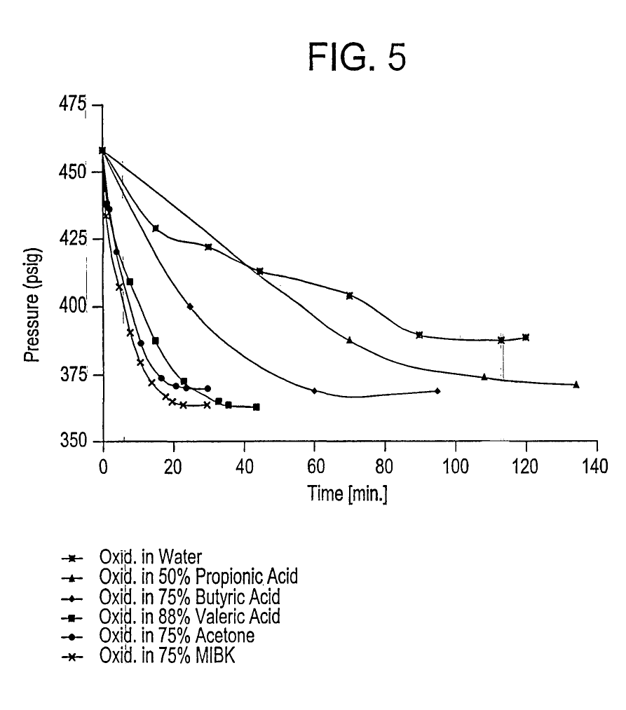

Several batch experiments were run utilizing propylene in order to determine the efficacy of the co-solvents and the appropriate time and temperature regimes. In the propylene batch procedure, a mixture of 30 g liquid, and unsupported palladium catalyst prepared from 0.75 g Pd(OAc)₂ as described hereinbelow and kept moist after preparation was placed in a 100 ml. Parr autoclave equipped with a stirrer. The autoclave was flushed twice with propylene during which time the stirrer was activated. The autoclave was then pressured with propylene to a pressure of 2.75 bar with stirring at 1200 rpm. External heating was used to cause the contents to attain a temperature of 80° C. at which point 29 bar air was added. A pressure drop was noted immediately and the reaction was terminated when the pressure drop had ceased. The reaction was usually terminated at about 2.5 hours. The rate of pressure drop and the composition of the product were then determined and recorded. A comparison of the pressure drop is shown in FIG. 5 identified as Propylene Oxidation: O₂ Consumption Rate Comparison. In FIG. 5, there is shown the reactor pressure vs. time in hours curves for propylene oxidation in water, 50% aqueous propionic acid, 75% aqueous butyric acid, 80% aqueous valeric acid, 75% aqueous acetone, and 75% aqueous methyl isobutyl ketone.

### EXAMPLE 1

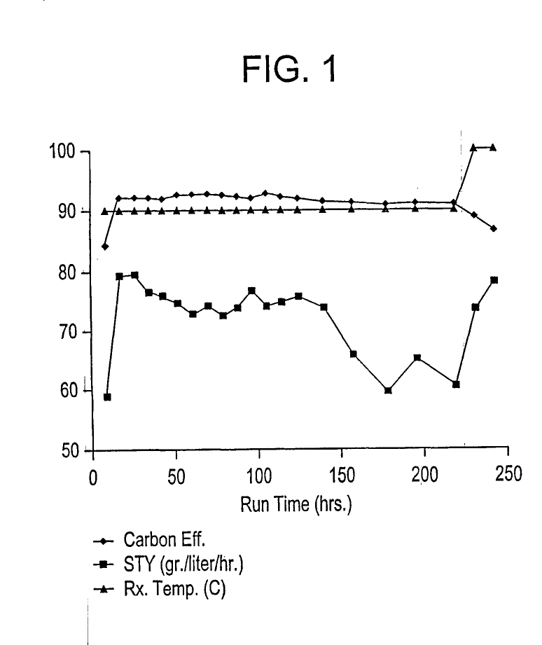

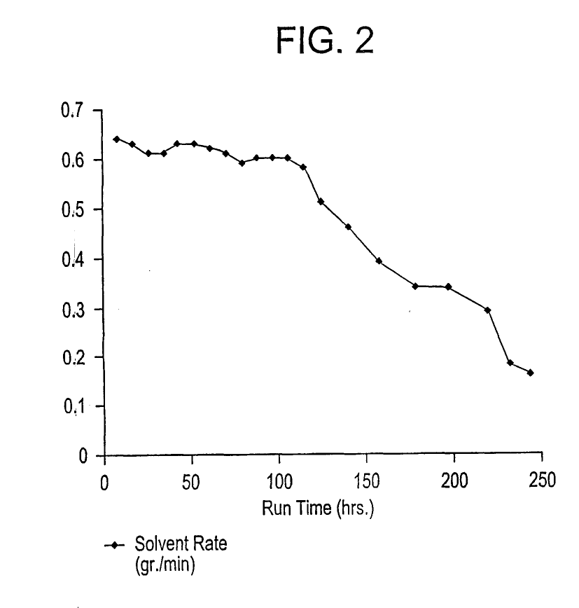

The following example of the manufacture of acrylic acid, which is not to be considered limiting to the scope of the invention, describes a continuous run of over 200 hours. In a continuous reactor with a total volume of 300 ml were placed 10 g of palladium acetate, 132 ml. of valeric acid, and 18 ml of water. The reactor was swept with propylene several times to remove any air and then pressured with propylene to an internal pressure of 7.8 bar. The reactor was heated to 80° C. and the contents were stirred for one hour. At that time a continuous stream of propylene and air (equimolar amounts of propylene and oxygen) was admitted and the pressure was raised to 32 bar. The temperature was held at 90° C. until near the end of the run where the temperature was increased to 100° C. Filter plugging was noted about halfway through the run, which required a reduced solvent flow and reduced the STY for the system. The propylene partial pressure in the reactor was about 3.1 bars based on the concentration of propylene in the vent gas. The reaction operated at about a 39% conversion of the oxygen. In the figures, FIG. 1 shows the carbon efficiency and STY of the reaction. Carbon efficiency is shown in percent based upon weight of carbon incorporated in the acrylic acid formed and the propylene converted to acrylic acid as determined by chromatographic analysis of the product. FIG. 2 shows the solvent recycle rate in grams per minute for the continuous run.

### EXAMPLE 2

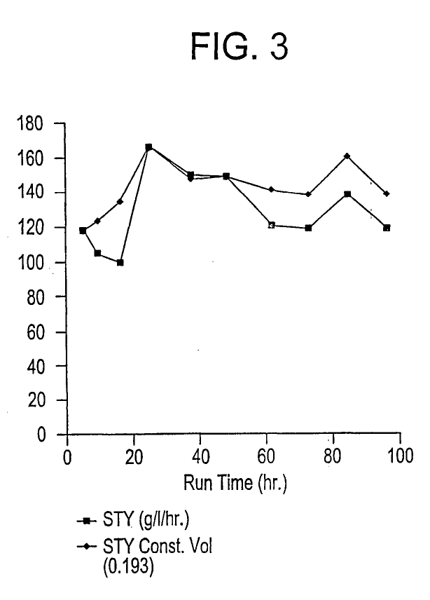

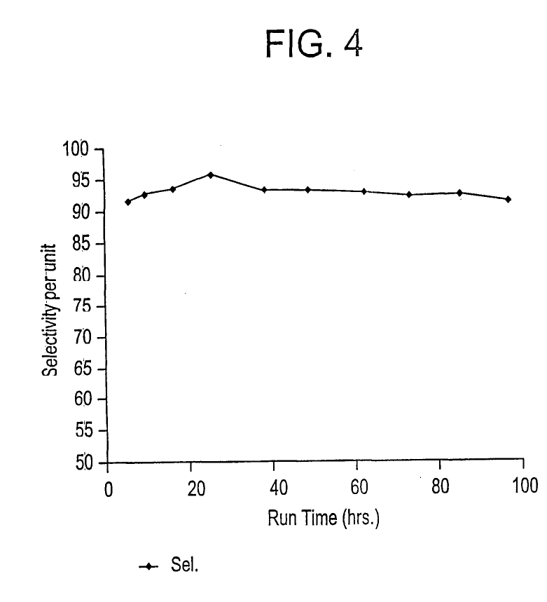

The following example of the manufacture of methacrylic acid, which is not to be considered limiting to the scope of the invention, describes a continuous run of 100 hours. In the reactor (as described above) methyl isobutyl ketone with 20% water loading was used as the solvent mixture, the pre-reduced (with propylene) palladium loading was 4.4%, temperature was 90° C. and pressure was 32 bars. Air was introduced at 2.5 std. liters/minute and isobutylene as liquid at 0.86 g/min. The mixture was stirred at 2000 rpm. FIG. 3. identifies the STY in grams/liter/hr and a Constant Volume STY. FIG. 4 is a plot of the selectivity to a mixture containing methacrolein, methacrylic acid, and esters as determined by vapor phase chromatography during the continuity of the run.

### EXAMPLE 3

Following is a typical batch oxidation of methacrolein.

A 100 cc high pressure Hastelloy C autoclave was charged with 0.35 grams of pre-reduced Palladium metal particles (typical reduction) with an average particle size of about 0.6 microns, 2.18 grams of redistilled methacrolein (to remove inhibitors), 26.8 grams of valeric acid and 3.7 grams of pure water. The mixture was heated to 90° C. with mixing (about 815 rpm) and about 30 bars of air were introduced. The oxygen was consumed in about 40 minutes. The reactor was vented to 9 bars and then refilled with air to 30 bars. The additional oxygen was consumed in about 47 minutes and the reactor was again depressured to 9 bars and then repressured with air to 30 bars. After the oxygen was mostly consumed in the third air charge, the reactor was cooled and the liquid analyzed by gas chromatography. The methacrolein concentration remaining was 0.034 wt. % or less than 1% of the original concentration of methacrolein. The concentration of methacrylic acid in the liquid was 5.084 wt. % or 63% of theoretical. Some methacrolein was lost with each depressurization to vent the nitrogen. Trace amounts of acetic acid, acrylic acid, and propionic acid (6.8 mole % of total methacrolein charge) were produced as byproducts.

### EXAMPLE 4

The following experiments demonstrate the preparation of esters when the oxidation was carried out in the presence of a primary alcohol.

A 100 cc Hastelloy C reactor was charged with 0.35 grams of palladium catalyst prepared by propylene reduction, 20.0 grams of t-butanol, 3.3 grams of methanol, and 3 ml (2 grams) of isobutylene liquid. The reactor was sealed and heated to 80° C. with mixing. The pressure in the reactor was 28 psig. An additional 402 psig of air was then added to the reactor and the reactor sealed. The pressure in the reactor was monitored as the oxygen was consumed. The pressure in the reactor remained constant after 25 minutes. The reactor was cooled and both the gas and liquid in the reactor were analyzed by GC and GC-MS. The gas phase analysis showed that about 90% of the oxygen had been consumed during the reaction. The liquid analysis indicated the presence of methyl formate, methacrolein; methyl methacrylate, and methacrylic acid in addition to the remaining reactants.

### EXAMPLE 5

A 100 cc Hastelloy C reactor was charged with 0.35 grams of palladium catalyst prepared by propylene reduction, 20.0 grams of t-butanol, 3.3 grams of methanol, and 2.03 grams of methacrolein.

The reactor was sealed and heated to 80° C. with mixing. The pressure in the reactor was 8 psig. An additional 444 psig of air was then added to the reactor and the reactor sealed. The pressure in the reactor was monitored as the oxygen was consumed. The pressure in the reactor remained constant after about 25 minutes. The reactor was cooled and the gas and liquid removed and analyzed by GC and GC-MS. The gas phase analysis showed that about 75% of the oxygen had been consumed during this time period. The liquid analysis indicated the presence of methyl formate, methyl methacrylate, and methacrylic acid in addition to the remaining reactants.

### EXAMPLE 6

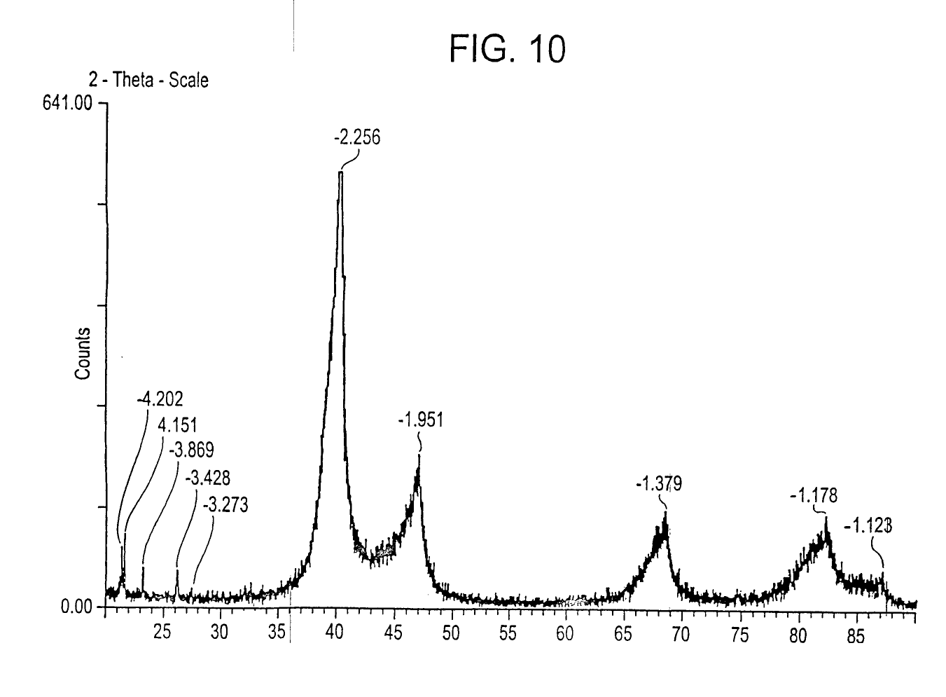

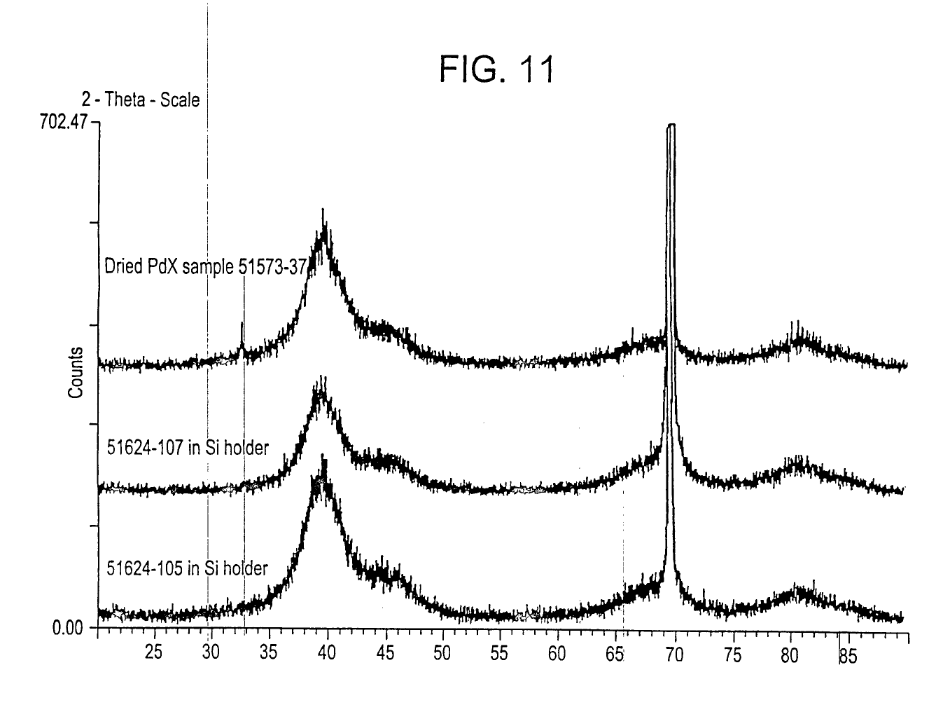

Four separate batches of palladium catalysts are produced according the process set forth in Example 1. The first repeat of Example 1 did not use valeric acid as the co-solvent, i.e. there was no organic solvent in the system, thus similar to the process of Lyons and Suld (EP 145 46781) which only uses water; the results are shown in FIG. 10 and which discloses sharp peaks indicative of a highly crystalline material. The second, third and fourth repeats of Example 1 did use valeric acid as the co-solvent; the results of these repeats are set forth in FIG. 11 and which discloses the broadened peak profiles which are indicative of a substantially amorphorus material.

The palladium salts used in the present invention include any carboxylate which can function to achieve the desired end result. These carboxylates include, without limitation. Pd acetate, Pd propionate, Pd trifluroacetate, and the like, Pd nitrates and Pd chlorides. The palladium metal, having a valence of “0”, can be either a simple palladium metal or a palladium metal ligand complex such as one of the following:

Tris(dibenzylideneacetone) dipalladium(0)

Palladiuim(0) complexed with polyglycidol polymers

Palladium(0) polysiloxane-bound bidentate mercaptan-amine complex

Poly(4-vinylpyridine-co-N-vinytpyrrolidone)-Palladium(0) complex.

1. A composition of matter consisting essentially of palladium and further characterized whereby the palladium component is manufactured by reducing a compound selected from the group consisting of palladium salts and oxidized palladium metals in an aqueous organic solvent with a reducing agent at sufficient temperature and pressure to produce a substantially amorphous palladium.

2. The composition as set forth in claim 1 wherein the palladium x-ray diffraction pattern has a d value of about 2.30 A and broadened peak profiles.

3. The composition as set forth in claim 1 wherein the palladium salt is palladium acetate.

4. The composition as set forth in claim 1 wherein the aqueous organic solvent comprises a member selected from the group consisting of a C₂-C₆ carboxylic acid, tertiaty-butanol, C₃-C₆ ketone and mixtures thereof.

5. The composition as set forth in claim 1 wherein the reduction is conducted at about 0° C. to about 150° C.

6. The composition as set forth in claim 1 wherein the reduction is conducted at from about 0° C. to about 90° C.

7. The composition as set forth in claim 1 wherein the reduction is conducted at from 1 to about 50 bar pressure.

8. The composition of claim 1 wherein the reducing agent is propylene and the aqueous organic solvent comprises valeric acid.

9. A composition of matter consisting essentially of palladium and further characterized by the palladium component is manufactured by reducing palladium acetate in an aqueous organic solvent with propylene at a temperature of about 0° C. to about 150° C. and a pressure of about 1 to about 50 bars to produce a substantially amorphorus palladium which has an x-ray diffraction pattern wherein the d value is about 2.30 A and there are broadened peak profiles.

10. The composition as set forth in claim 9 wherein the aqueous organic solvent contains as a co-solvent selected from the group consisting of a C₂-C₆ carboxylic acid, tertiary-butanol, C₃-C₆, ketone and mixtures thereof.

11. The composition as set forth in claim 10 wherein the co-solvent is selected from the group consisting of acetic acid, propionic acid, butyric acid, valeric acid, hexanoic acid and mixtures thereof.

12. The composition as set forth in claim 10 wherein the co-solvent is selected from the group consisting of acetone, methyl ethyl ketone, methyl isobuty! ketone and mixtures thereof.

13. A palladium containing catalyst whereby the palladium component (1) is manufactured by reducing palladium salts in an aqueous organic solvent with propylene and (2) the X-ray diffraction pattern has a d value of about 2.30 A and broadened peak profiles.

14. The catalyst of claim 13 wherein the palladium salt is palladium acetate.

15. Catalyst of claim 13 wherein the catalyst is supported.

16. The catalyst of claim 13 wherein the catalyst is unsupported.

17. The catalyst of claim 1 wherein the palladium component is prepared from a oxidized palladium metal.

18. The catalyst of claim 1 wherein the palladium component is prepared from a palladium metal ligand complex.

19. A continuous method for the manufacture of acrylic acid or methacrylic acid which comprises: a) continuously reacting the precursor with oxygen in a continuous reactor in the presence of a palladium catalyst suspended in an aqueous solvent containing as a co-solvent a maximum concentration of a C₂-C₆ carboxylic acid, tert.-butanol, or C₃-C₆ ketone, b) recovering the acrylic acid or methacrylic acid formed, and d) recycling the solvent to the reactor.

20. The method of claim 19 wherein the precursor is propylene.

21. The method of claim 19 wherein the precursor is isobutylene.

22. The method of claim 19 wherein the precursor is acrolein.

23. The method of claim 19 wherein the precursor is methacrolein.

24. The method of claim 19 wherein the precursor to oxygen ratio is from about 1:1 to about 1:5.

25. The method of claim 19 wherein the reaction is carried out at from about 50° C. to about 150° C.

26. The method of claim 25 wherein the reaction is carried out at from about 60° C. to about 90° C.

27. The method of claim 19 wherein the reaction is carried out at from about 1 to about 50 bar.

28. The method of claim 19 wherein the co-solvent is propionic acid.

29. The method of claim 19 wherein the co-solvent is valeric acid.

30. The method of claim 19 wherein the co-solvent is butyric acid.

31. The method of claim 19 wherein the co-solvent is acetone.

32. The method of claim 19 wherein the co-solvent is methyl isobutyl ketone.

33. The composition as set forth in claim 19 wherein the palladium x-ray diffraction pattern has a d value of about 2.30 A and broadened peak profiles.

34. The composition as set forth in claim 19 wherein the palladium salt is palladium acetate.

35. The method of claim 19 wherein the propylene to oxygen ratio is from about 1:1 to about 1:5.

36. The method of claim 35 wherein steps a) and b) of the reaction are carried out at from about 50° C. to about 150° C.

37. The method of claim 19 wherein steps a) and b) of the reaction are carried out at from about 60° C. to about 90° C.

38. The method of claim 19 wherein steps a) and b) of the reaction is carried out at from about 1 to about 50 bar.

39. The method of claim 48 wherein the precursor is propylene.

40. The method of claim 48 wherein the precursor is isobutylene.

41. The method of claim 48 wherein the precursor is acrolein.

42. The method of claim 48 wherein the precursor is methacrolein.

43. The method of claim 48 wherein the precursor is oxygen ratio is from about 1:1 to about 1:5.

44. The method of claim 48 wherein the reaction is carried out at from about 50° C. to about 150° C.

45. The method of claim 44 wherein the reaction is carried out at from about 60° C. to about 90° C.

46. The method of claim 48 wherein the reaction is carried out at from about 1 to about 50 bar.

47. The composition of claim 1 wherein the reducing agent is propylene and the aqueous organic solvent comprises valeric acid.

48. The method of claim 27 wherein the aqueous organic solvent comprises valeric acid.

49. A method for the manufacture of C₁-C₆ esters from an acid selected from the group consisting of acrylic acid and methacrylic acid by the oxidation of a precursor comprising the steps of: a) in a continuous reactor reacting an oxygen-containing gas, a C₁-C₆ primary alcohol, and a precursor selected from the group consisting of propylene, acrolein, isobutylene, methacrolein, and mixtures thereof in the presence of palladium catalyst prepared by the reduction of a compound selected from the group consisting of palladium salts and oxidized palladium metals with propylene in an oxygen-free organic solvent system comprising as a co-solvent a C₂-C₆ carboxylic acid, b) recovering the acrylic ester or methacrylic ester formed, and c) recycling the solvent system to the reactor.
